(19) United States
(12) Patent Application Publication
(10) Pub. No.: US 2011/0042383 A1
(43) Pub. Date: Feb. 24, 2011

(54) HYDROCARBON COLLECTION SYSTEM

(76) Inventor: William Boroughf, Orchard Lake, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/861,374

(22) Filed: Aug. 23, 2010

Related U.S. Application Data
(60) Provisional application No. 61/235,849, filed on Aug. 21, 2009.

(51) Int. Cl. F16N 31/02; B65D 1/34

(52) U.S. Cl. 220/560.03; 220/573

(57) ABSTRACT

In one embodiment, a hydrocarbon containment system for placement under a vehicle is provided with a skid having a base. The base has at least one drain aperture for facilitating fluid communication through the base. A tubular dam formed of a hydrophobic hydrocarbon permeable fabric is disposed upon the base. The dam includes granular material capable of collecting hydrocarbons. A blanket is provided having laterally adjacent sheets of water permeable fabric with a layer of the granular material disposed between the sheets. The blanket is replaceably attached to the dam for replacing the blanket after collecting sufficient hydrocarbons.

### CROSS-REFERENCE TO RELATED APPLICATIONS

This application claims the benefit of U.S. provisional Application No. 61/235,849 filed Aug. 21, 2009. The disclosure of which is incorporated in its entirety by reference herein.

### BACKGROUND

1. Field of the Invention

One or more embodiments of the present invention generally relate to a hydrocarbon collection system for placement under, among other things, a vehicle. In at least one embodiment, the system includes a replaceable blanket that collects hydrocarbons.

2. Background Art

There is a “need” for a system for retaining oil or fuel that would escape from vehicles, such as earth moving equipment, when they are idled for the night, among other times.

With respect to the earth moving equipment, failure to capture any of the hydrocarbon fluids could result in a $10,000 dollar fine per day. A current (prior art) method used to retain these fluids is to place a plastic children's swimming pool (approximately six feet in diameter) beneath the earthmoving equipment when parked over night. Additionally, a large rock may be placed in the pool to act as ballast for maintaining a position of the pool beneath the equipment.

However, even if the pool stays in place overnight, other problems could occur. For instance, if it rains during the night, the pool may fill with water along with the current hydrocarbon fluids thereby creating a clean up problem. The hydrocarbon needs to be absorbed with some sort of rag then the water must be pumped from the pool. Great care must be used as to avoid any of the hydrocarbons from getting on the ground (dirt). This function of maintenance may require the use of one or more full time people to comply with the EPA requirements.

### SUMMARY

In at least one embodiment, a hydrocarbon containment system for placement under a vehicle is provided with a skid for resting upon an underlying surface. The skid may comprise a generally planar base with a raised lip formed about a periphery of the base. The planar base may include at least one drain aperture for facilitating fluid communication through the base. A tubular dam formed of a hydrophobic hydrocarbon permeable fabric is also provided. The dam may be disposed upon the base and abutting the lip. In at least one embodiment, the dam includes granular material capable of collecting hydrocarbons. A blanket releasably fastened to the tubular dam is provided. The blanket may comprise laterally adjacent sheets of water permeable fabric with a layer of the granular material disposed between the sheets. The blanket may be quilted to separate the layer of material into pockets. The blanket can be adapted for replacement after collecting sufficient hydrocarbons.

In another embodiment a hydrocarbon containment system having a blanket for collecting hydrocarbon material from a fluid is provided. The blanket includes a pair of fabric sheets that are orientated adjacent to each other. Each sheet has a longitudinal length and a transverse width. The blanket also includes a layer of granular material disposed between the sheets and adapted to attach to hydrocarbons. In at least one embodiment, the sheets are attached to one another at longitudinal and transverse spaced intervals, thereby distributing the enclosed material into pockets.

In yet another embodiment, a hydrocarbon containment system for placement under a vehicle is provided with a skid for resting upon a surface. The skid includes a base that is capable of draining fluids therethrough. The system also includes a tubular dam formed of a hydrophobic fabric which is capable of allowing hydrocarbons to permeate therethrough. The dam is supported on the base and contains granular material that is capable of collecting hydrocarbons. A collector is positioned adjacent the dam. The collector includes spaced apart layers that form a chamber, and granular material is disposed within the chamber.

### BRIEF DESCRIPTION OF THE DRAWINGS

FIG. 1 is a front perspective view of a prior art hydrocarbon collection system;

FIG. 2 is a top plan view of a hydrocarbon collection system according to an embodiment of the present invention;

FIG. 3 is a section view of the hydrocarbon collection system of FIG. 2, along section line 3-3, illustrated with mounting stakes;

FIG. 4 is a front perspective view of a hydrocarbon collection system according to another embodiment of the present invention;

FIG. 5 is a top plan view of a hydrocarbon collection system according to yet another embodiment of the present invention, with one component shown fragmented;

FIG. 6 is a top perspective view of a hydrocarbon collection system according to another embodiment of the present invention, with one component shown fragmented;

FIG. 7 is a section view of the hydrocarbon collection system of FIG. 6, along section line 7-7;

FIG. 8 is a top plan view of a hydrocarbon collection system according to yet another embodiment of the present invention; and

FIG. 9 is a section view of the hydrocarbon collection system of FIG. 8, along section line 9-9.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; and, unless expressly stated to the contrary, measurement of a property is determined by the same technique as previously or later referenced for the same property.

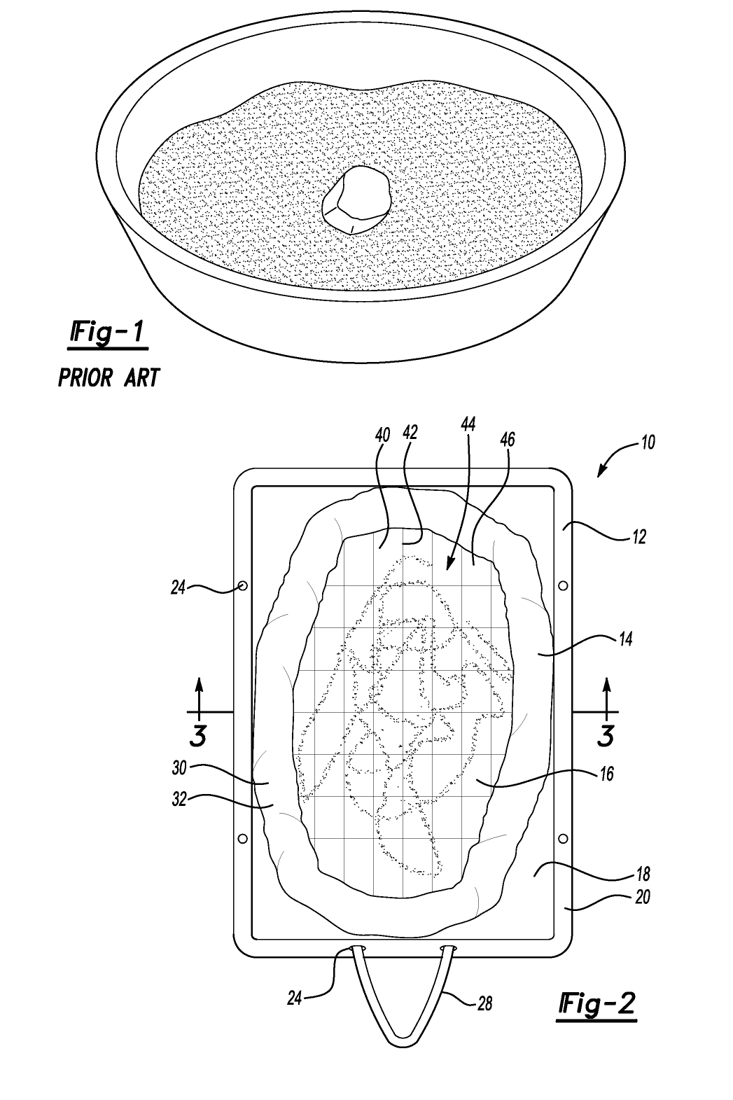

FIG. 1 illustrates an example of a prior art system for collecting hydrocarbons underneath a vehicle. Such a system includes a plastic swimming pool, that is approximately six feet in diameter. A rock as illustrated (or other weighted material) is placed in the pool to act as a balast, to keep the pool from moving. Some of the deficiencies of such a system have been discussed above in the Background Art Section.

With reference to FIG. 2, a hydrocarbon collection system for placement under a vehicle in accordance with an embodiment of the present invention is illustrated and is generally referenced by numeral 10. The system 10 is placed under a vehicle, e.g. an earth mover or other machinery susceptible to fluid and/or oil leaks, for receiving fluid that leaks from the vehicle. The system 10 is configured for separating and collecting any hydrocarbons in the received fluid. The system 10 retains the hydrocarbons, and allows any water from the received fluid to permeate through the system 10. In the illustrated embodiment, the hydrocarbon collection system 10 includes a skid 12, a dam 14 and a blanket 16 operatively coupled to one another. As used herein, unless clearly stated otherwise or is clearly not the case from the context, the term “coupled” means arranged in a cooperating relationship, but not necessarily physically attached. For example, in other embodiments, the skid 12, the dam 14 and/or the blanket 16 may be coupled to each other, without being physically attached to each other.

The skid 12 rests upon an underlying surface, such as the ground. In the illustrated embodiment, the skid 12 includes a generally planar polygonal base 18 with a raised lip 20 formed about a periphery of the base 18. The skid 12 may be formed from a unitary sheet of plastic, such as polyethylene, having a thickness of less than one eighth of an inch, (less than 3.2 mm). The raised lip 20 may be created by vacuum forming the plastic. One embodiment of the system 10 includes a polygonal skid 12 having a length of forty inches and a width of forty inches. However, any suitable size and shape is contemplated.

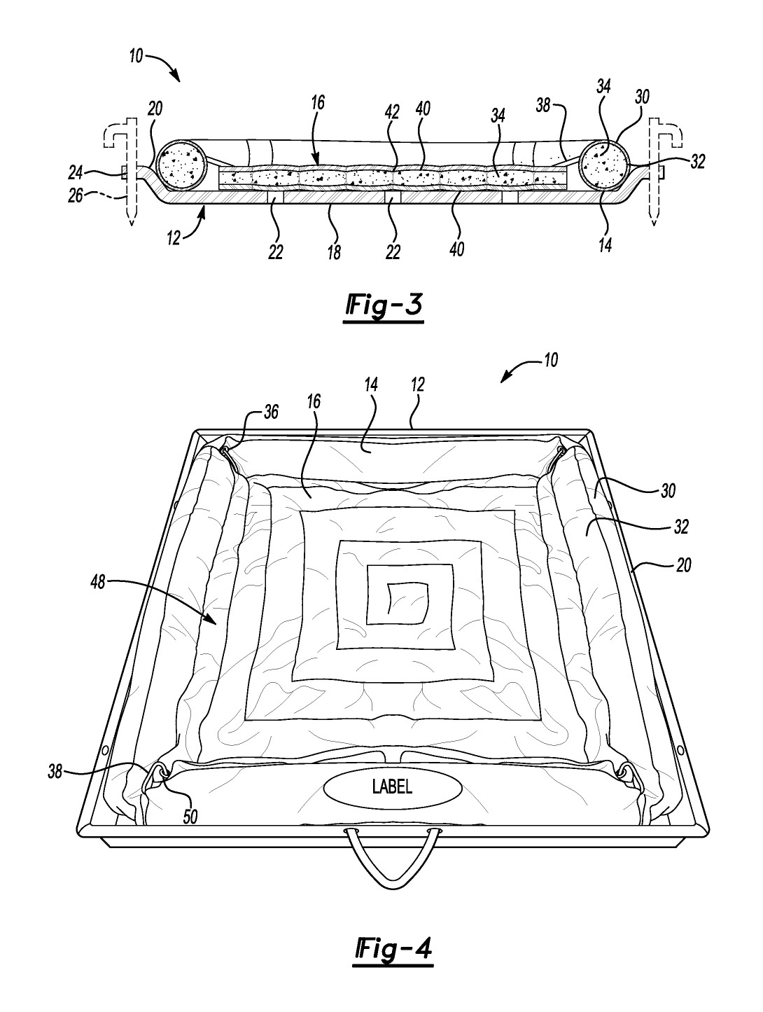

Referring to FIGS. 2-3, the illustrated skid 12 includes a series of drain apertures 22 for allowing water to drain through the system 10. The drain apertures 22 project through the base 18. Generally speaking, the drain apertures 22 are sized small enough to prevent any components of the system 10 from passing through.

The skid 12 illustrated in FIGS. 2-3, also includes a series of attachment apertures 24 for anchoring and moving the system 10. The attachment apertures 24 project through the raised lip 20. Attachment apertures 24 are sized for receiving stakes 26 for anchoring the system 10 in a desired location. Additionally attachment apertures 24 may be sized for receiving a pull cable 28. A user may use the pull cable 28 to drag the system 10 to a desired location.

With reference to FIGS. 2-4, the dam 14 is provided for repelling water and creating a barrier around the system 10. The dam 14 includes a tubular sock 30. In at least one embodiment, the sock 30 is formed from a hydrophobic fabric. The fabric typically will have a weight of 1.6 to 3.6 oz. per square yard. Other embodiments of the system 10 envision a fabric having a weight of 1.6 to 2.6 oz. per square yard. One embodiment of the system 10 includes a Needle Point Polypropylene (NPPP) nonwoven fabric by NuTex Concepts (Lenair, N.C.), having a weight of 2.1 oz. per square yard. The sock 30 repels water while allowing hydrocarbons to permeate through. The sock 30 is flexible and may be configured to assume the shape of its container. The ends of the sock 30 are closed and/or attached to one another to form a sock ring 32. In the illustrated embodiment, the sock ring 32 is oriented upon the base 18, such that an outer perimeter of the sock ring 32 may abut the lip 20. The dam 14 forms a barrier around the system 10 to prevent external fluid (e.g., ground water) from flowing into the system 10. FIG. 2 illustrates an embodiment of the system 10 having a generally elliptically shaped sock ring 32, where limited peripheral portions of the sock ring 32 abut the lip 20. FIG. 4 illustrates another embodiment of the system 10, where the sock ring 32 is generally rectangular in shape, where substantial peripheral portions of the sock ring 32 abut the lip 20.

The dam 14 includes granular hydrocarbon collecting material 34 for trapping hydrocarbons. The granular material 34 is enclosed within the sock 30 and collects hydrocarbons that permeate into the sock 30. The granular material 34 may be an absorbent, that absorbs the hydrocarbons into the material, or it may be an adsorbent, where the hydrocarbons attach to the exterior of the material 34. For example, the granular material 34 may be peat moss, polypropylene, corn cob, clay, vermiculte, recycled paper or recycled plastic, to name a few. The weight of the dam 14 is typically between four and eight pounds. And one pound of the granular material 34 typically retains (e.g., absorbs or adsorbs) between six and nine pounds of hydrocarbons (depending on viscosity).

In one embodiment of the system 10, the dam 14 includes six pounds of a treated peat moss called Cansorb™, from AVP Cansorb (Nova Scotia, Calif.). Cansorb™ has a hydrocarbon collection capacity of eight pounds of hydrocarbons for each pound of absorbent. Therefore the dam 14 of this embodiment can collect approximately forty eight pounds of hydrocarbons.

In the illustrated embodiment, the dam 14 includes a series of dam grommets 36 for attaching the dam 14 to the blanket 16. The sock 30 includes apertures (not shown) that are spaced apart along the length of the sock. For example, the sock apertures may be spaced apart to align with the corners of the skid 12. The dam grommets 36 are formed about the sock apertures. Each dam grommet 36 is configured for receiving a fastener 38 (e.g., carabiner) and for sealing the corresponding sock aperture. The fastener 38 is used to attach the dam 14 to the blanket 16.

The blanket 16 is provided for collecting hydrocarbons. In at least one embodiment, the blanket 16 includes a pair of laterally adjacent sheets 40 encapsulating a mass of the granular material 34. The sheets 40 may be formed from a water permeable fabric, having a weight of 1.5 to 3.6 oz. per square yard. Other embodiments of the system 10 envision a water permeable fabric having a weight of 1.5 to 2.5 oz. per square yard. In one embodiment of the system 10, sheets 40 are formed of Spunbond Polypropylene based nonwoven fabric, (SBPP) from NuTex Concepts (Lenair, N.C.), having a weight of 2.0 oz per square yard. The sheets 40 are configured for allowing water and hydrocarbons to permeate through.

The blanket 16 includes a volume of the granular material 34 disposed between the sheets 40. Similar to that of the dam 14, the granular material 34 of the blanket 16 may be an absorbent or an adsorbent, and may be selected from any of the examples above. The blanket 16 may hold 2.0 to 7.0 pounds of granular material 34. Other embodiments of the system 10 envision a blanket 16 holding 3 to 6 pounds of granular material 34. In one embodiment of the system 10, the blanket 16 holds 4.5 pounds of Cansorb™, granular material 34. Cansorb™ has a hydrocarbon collection capacity of eight pounds of hydrocarbons for each pound of absorbent. Therefore such a blanket 16 can collect approximately thirty six pounds of hydrocarbons.

The sheets 40 of the blanket 16 are attached, or otherwise secured to one another to enclose the granular material 34. The sheets 40 may be attached together by a high speed quilting process. The quilting process provides a series of joints 42 along the perimeter and interior surface of the blanket 16 for enclosing the granular material 34. The granular material 34 may be disposed between the sheets 40 prior to the quilting process, after the quilting process, or in increments during the quilting process. One embodiment of the system 10, envisions disposing the granular material 34 between the sheets 40 prior to the quilting process, where a quilting machine shifts the granular material 34 away from a location prior to forming the joint 42. Alternate embodiments of the system 10 envision a heat sealing process for forming joints in the blanket 16.

In at least one embodiment, the quilting process is configured for providing patterns having generally uniform hydrocarbon absorbtion/adsorbtion properties throughout the blanket 16. In this embodiment, the quilting process is configured to form joints 42 in patterns that provide a generally even distribution of the granular material 34 throughout the blanket. Without joints 42 the granular material 34 within the blanket 16 could congregate in one area, and not be present in another, thereby resulting in non uniform absorbtion/adsorbtion properties of the blanket 16. One embodiment of the system 10 includes a tessellated blanket pattern 44, and is illustrated in FIG. 2. The tessellated pattern 44 includes an array of pockets 46 of generally the same shape and volume. Another embodiment of the system 10 includes a spiral blanket pattern 48, and is illustrated in FIG. 4. It should be understood however that non-uniform pockets could be provided.

In the illustrated embodiments, the blanket 16 includes a series of blanket grommets 50 for attaching the blanket 16 to the dam 14. The blanket 16 includes apertures (not shown) that are spaced apart along the perimeter of the blanket 16. For example, the blanket apertures may be formed at the corners of the blanket 16 to align with the corners of the skid 12 and dam grommets 36. The blanket grommets 50 are formed about the blanket apertures. Each blanket grommet 50 is configured for receiving the fastener 38 (e.g., carabiner) and for sealing the corresponding blanket aperture.

The blanket 16 is configured to be selectively replaceable for prolonging the life of the system 10. The blanket 16 can be attached to the dam 14 by the fasteners 38. When the blanket 16 is determined to have reached its capacity, or near capacity, of collected hydrocarbons, the blanket 16 may be replaced. To replace the blanket 16 of the illustrated embodiment, the user detaches the fasteners 38 from the used blanket 16, and reattaches the fasteners to a new blanket 16. The removed blanket 16 can then be disposed in a hazardous waste drum in compliance with local codes. The disposal cost of the blanket 16 should depend on its weight. Therefore a blanket 16 having granular material 34 of high hydrocarbon collection capacity (e.g., Cansorb™) should have lower disposal costs than a blanket with a low hydrocarbon collection capacity granular material 34 (e.g., clay).

The skid 12 helps to maintain the overall shape of the system 10. The dam 14 conforms to the shape of its container and the blanket 16 is attached to the dam 14, therefore the skid 12 maintains the shape of the system 10. Alternate embodiments of the system envision skids of various shapes and sizes depending on the application. For example large rectangular shaped systems may be used for large vehicle applications e.g., earth movers. Conversely, small systems may be used for smaller vehicle applications, e.g., cars or motorcycles. Alternate embodiments of the system envision skids 12 having a cylindrical or elliptical shaped base.

Packaging of the system 10 is simplified by the skid 12. Since the skid helps maintain the overall shape of the system 10, the system 10 may be assembled on the skid 12 and packaged in common shipping containers.

The skid 12 protects the system 10 during transportation at the work site. The system 10 is particularly suited for use at a construction or work site. Typical works sites have rough or uneven ground surfaces. The dam 14 and blanket 16 are formed of fabrics that may wear or become damaged if they were dragged across such a work site. Therefore the base 18 of the skid 12 also provides a smooth contact surface for pulling the system 10 across a worksite, without damaging the dam 14 or blanket 16.

The system 10 may be left anchored at a location or “parking spot” at a work site. Typical maintenance schedules for the prior art plastic pool collection systems involve gathering and cleaning the pools daily, so that they do not fill with water. Since the system 10 allows water to drain through the skid 12, the system may be left staked at a set position at the work site for a period of time, thereby minimizing maintenance efforts.

Other embodiments are envisioned for simplified versions of the system 10, typically by removing one of the skid 12, dam 14 or blanket 16.

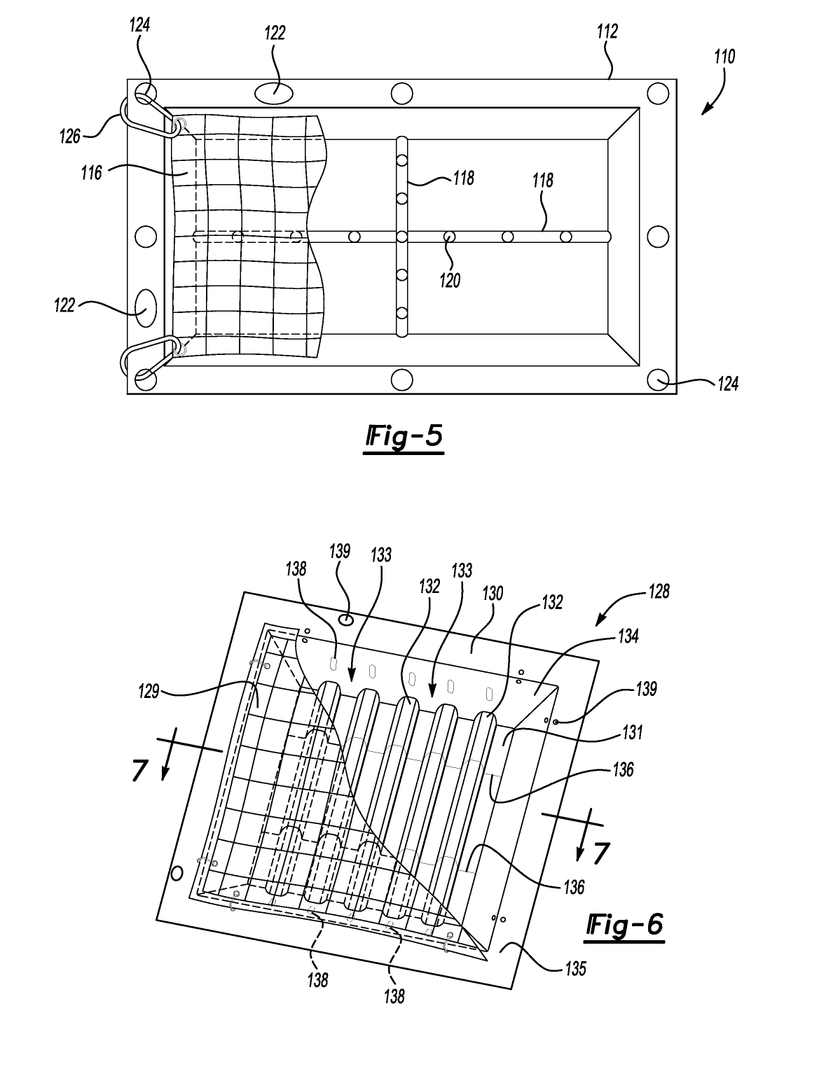

FIG. 5, illustrates one embodiment of a simplified hydrocarbon collection system 110. The simplified system 110 includes a skid such as pan 112 coupled to a blanket 116. The main difference between the simplified system 110 and the above mentioned system 10, is that the blanket 116 is coupled directly to the pan 112. The simplified system 110 does not include a dam, rather the sides of the pan 112 extend upward to help contain fluid within the system 110. The simplified system 110 includes a pair of intersecting raised ridges 118 formed in the base of the pan 112. Drainage holes 120 are formed in the pan 112 and spaced along the ridges 118. The ridges 118 raise the blanket 116 to help facilitate draining of water from the system 110 and through the drainage holes 120. Mounting apertures 122 may be formed along the periphery of the pan 112 for receiving stakes (not shown) for anchoring the system 110. Fastener apertures 124 may also be formed along the periphery of the pan 112. Fasteners 126 (e.g., carabiners) may be used to attach to the blanket 116 to the pan 112.

Another embodiment of the hydrocarbon collection system envisions the pan 112 of FIG. 5 having a water permeable polymeric material sealing the top of the pan (not shown). Such an embodiment would contain loose granular material placed within the pan. The drain holes would be sized so that they are smaller than the granular material.

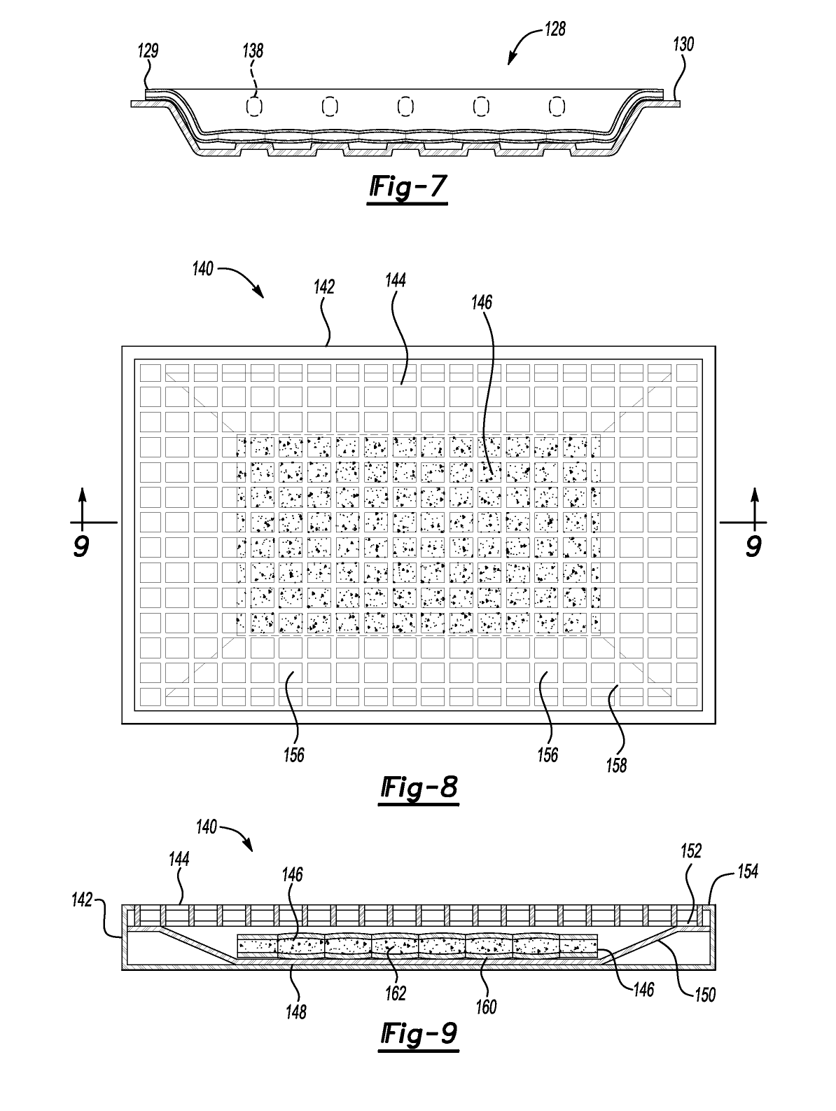

FIGS. 6 and 7 illustrate another embodiment of the hydrocarbon collection system 128. Similar to the simplified system 110 of FIG. 5, the system 128 includes a blanket 129 that is coupled to a skid such as corrugated pan 130, without a dam. The system 128 is configured for separating and collecting any hydrocarbons in the received fluid. The system 128 may be configured as a weir system, whereby any water within the received fluid permeates through the bottom of the system 128. Alternatively, the system 128 may also be configured as a containment vessel, whereby any water in the received fluid collects or pools in the bottom of the pan 130 before draining from an intermediate portion of the system 128.

The pan 130 rests upon an underlying surface, such as the ground. In the illustrated embodiment, the pan 130 includes a generally planar polygonal base 131 with a series of raised ridges 132 formed in the base 131. The ridges 132 may be aligned parallel to one another, and extend along a length of the base 131. Channels 133 are formed between adjacent ridges 132 for collecting liquid. The pan 130 includes tapered side walls 134 that extend upward from the base 131. A lip 135 is formed about a periphery of the pan 130 and extends outward from the side walls 134. The pan 130 may include apertures 139 formed in the lip 135 for attaching the blanket 129 to the pan 130, and for receiving mounting stakes or pull cables (not shown).

The pan 130 may be formed from a unitary sheet of plastic, such as polyethylene, having a thickness of less than one eighth of an inch, (less than 3.2 mm). The ridges 132 and lip 135 may be created by vacuum forming the plastic. One embodiment of the system 128 includes a pan 130 having an overall length of forty five inches and an overall width of forty five inches with five parallel ridges 132 formed in the base 131, as shown in FIG. 6. Another embodiment of the system 128 contemplates a smaller pan 130 having an overall length of twenty two inches and an overall width of twenty two inches with two parallel ridges 132 formed in the base 131 (not shown).

The blanket 129 is provided for collecting hydrocarbons. The blanket 129 may include a pair of laterally adjacent sheets encapsulating a mass of the granular material, as described above for the embodiments of FIGS. 2-4. In the illustrated embodiment, the blanket 129 is coupled to the apertures 139 and rests atop the ridges 132.

In one embodiment, the system 128 is configured as a weir system, whereby water permeates through the blanket 129 to drain from the bottom of the system 128. Drain seams 136 are formed into the base 131 and extend between opposing side walls 134. In one embodiment two parallel seams 136 are formed in the base 131. The seams 136 may be formed during the molding process, or cut or otherwise formed afterwards. The drain seams 136 may be transversely oriented to the parallel ridges 132. The ridges 132 raise the blanket 129 above a lower portion of the base 131, thereby allowing any accumulated liquid to flow to the seams 136 and drain from the system 128.

In another embodiment, the system 128 is configured as a containment vessel whereby water permeates through the blanket 129 and collects in the channels 133 before draining from an intermediate portion of the system 128. The corrugated pan 130 includes drainage holes 138 formed into the side walls 134 of the pan 130, without any drain holes or seams formed in the base 131. The drainage holes 138 may be oriented above the top of the ridges 132. The drainage holes 138 may also be longitudinally aligned with the ridges 132.

Raising the drainage holes 138 reduces the risk of any hydrocarbons inadvertently draining from the pan 130. In rare occurrences, hydrocarbons may permeate through or around a portion of the blanket 129. For example, hydrocarbons may pass through a portion of the blanket 129 that has become saturated (with hydrocarbons) or has been damaged (e.g. a tear in the blanket). Additionally, hydrocarbons may flow around a blanket 129 that is not properly coupled to the pan 130. Hydrocarbons tend to sheet or accumulate as a layer on top of water. Liquid (water and any hydrocarbons) that accumulates in the base 131 will rise and contact the blanket 129 before reaching the drainage holes 138. Therefore the blanket 129 would have a second opportunity to collect any hydrocarbons received by the system 128, before the fluid drains out of the raised drainage holes 138.

In one embodiment of the system 128, the pan 130 is configured as a vessel for holding approximately three gallons of liquid. The pan 130 is formed with an overall length of forty five inches and an overall width of forty five inches with five parallel ridges 132 formed in the base 131. Each drainage hole 138 is positioned approximately one and a half inches above the lower portion of the base 131. The pan 130 can hold approximately three gallons of liquid below the blanket 129.

Another embodiment of the hydrocarbon collection system envisions a tapered funnel positioned over the collection system (not shown). Such a tapered funnel would allow the system to span a larger leak area, or could accommodate a system having a smaller surface area.

Another embodiment of the hydrocarbon collection system envisions a tapered platform encircled by a dual layered tubular sock ring (not shown). The platform of such an embodiment may be formed of a plastic configured to repel fluids containing both water and hydrocarbons. The fluid would run off of the platform to be received by the sock ring. The outer layer of the sock ring would be formed of a water permeable material, thereby allowing water to drain about the perimeter of the system. The innerlayer of the sock would be formed of a hydrophobic material, configured to repel water, but allow hydrocarbons to permeate within. Granular material is enclosed within the inner layer of the sock for collecting hydrocarbons.

With reference to FIGS. 8-9, a hydrocarbon collection system for placement under a vehicle is illustrated in accordance with an embodiment of the present invention and is generally referenced by numeral 140. The system 140 is placed under a raised vehicle and configured for supporting the weight of a user while collecting hydrocarbons from drained fluid. The system 140 is suited for large maintenance projects, such as removing a fuel or oil line from a vehicle. The system 140 includes a skid such as pan 142, a removable grid 144 and a blanket 146 coupled to one another.

The system 140 is configured for collecting hydrocarbons from the received fluid. The system 140 retains the hydrocarbons, and allows any water from the received fluid to accumulate in the system 140, until the user is able to drain out the water. Alternate embodiments of the system 140 contemplate a weir system with drain holes formed in the pan 142.

The pan 142 provides a vessel for collecting fluid. The pan 142 rests upon an underlying surface, below a raised vehicle. The pan 142 includes a polygonal base 148 with tapered walls 150 extending from a lower portion of the base 148. A raised ledge 152 is formed about an upper portion of the tapered walls 150. The ledge 152 is oriented generally parallel to the base 148. A raised lip 154 transversely extends from an outer peripheral portion of the ledge 152. In one embodiment, the pan 142 has an overall length of five feet and an overall width of four feet.

The grid 144 supports the user while allowing fluid to pass through to the pan. The grid 144 is generally planar in shape, and includes an array of apertures 156 formed through a rigid structure 158. A peripheral edge of the grid 144 rests on the ledge 152 and abuts the lip 154 of the pan 142. During maintenance any fluids that drain or leak from the vehicle pass through the grid 144 and collect in the pan 142.

The system 140 is configured to support at least three hundred and fifty pounds for supporting the weight of an average user and their tools during maintenance. Both the pan 142 and the grid 144 may each be formed by injection molding a plastic, such as polycarbonate expanded structural foam. One embodiment of the system 140 includes a pan 142 and a grid 144 both molded from CALIBRE® SF 7070 which is a seven percent glass reinforced structural foam polycarbonate resin, from Dow Chemical (MI). However, any suitable size, shape and material is contemplated.

The blanket 146 is provided for collecting hydrocarbons. The blanket 146 rests on a lower portion of the base 148. The tapered walls 150 act as a funnel to direct fluid towards the blanket 146. As described above, the blanket 146 includes a quilted, water permeable fabric 160, that encloses granular material 162.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hydrocarbon containment system for placement under a vehicle, the system comprising:
a skid for resting upon an underlying surface, the skid having a generally planar base with a raised lip formed about a periphery of the base, the planar base having at least one drain aperture for facilitating fluid communication through the base;
a tubular dam formed of a hydrophobic hydrocarbon permeable fabric, the dam being disposed upon the base and abutting the lip, the dam having granular material capable of collecting hydrocarbons; and
a blanket releasably fastened to the tubular dam, the blanket comprising laterally adjacent sheets of water permeable fabric and a layer of the granular material disposed between the sheets, the blanket being quilted to separate the layer of material into pockets;
wherein the blanket is adapted for replacement after collecting sufficient hydrocarbons.

2. A hydrocarbon containment system comprising:
a blanket for collecting hydrocarbon material from a fluid, the blanket provided with:
a pair of fabric sheets oriented adjacent to each other, each sheet having a longitudinal length and a transverse width; and
a layer of granular material disposed between the sheets and adapted to attach to hydrocarbons;
wherein the sheets are attached to one another at longitudinal and transverse spaced intervals, for distributing the enclosed granular material into pockets.

3. The system of claim 2 wherein the fabric sheets are water permeable.

4. The system of claim 2 wherein the layer of granular material absorbs hydrocarbons.

5. The system of claim 2 wherein the layer of granular material adsorbs hydrocarbons.

6. The system of claim 2 further comprising a skid for supporting the blanket, the skid provided with:
a base for resting upon an underlying surface; and
side walls extending outward from the base, the side walls having a lip formed about an outer peripheral edge.

7. The system of claim 6 wherein the skid further comprises at least one drain aperture projecting through the base for facilitating draining of the fluid from the system.

8. The system of claim 6 wherein the skid further comprises at least one drain aperture projecting through the side walls for facilitating draining of the fluid from the system.

9. The system of claim 6 wherein the skid further comprises raised ridges formed in the base and adapted to offset the blanket away from a lower surface of the base.

10. The system of claim 9 wherein the skid further comprises at least one drain aperture projecting through the raised ridges for facilitating draining the fluid from the system.

11. The system of claim 9 wherein the skid further comprises drain seams cut through the base and transversely oriented relative to the raised ridges.

12. The system of claim 6 wherein an outer periphery of the blanket is releaseably attached to the lip of the skid by at least one fastener for replacing the blanket after collecting sufficient hydrocarbons.

13. The system of claim 6 further comprising a tubular dam formed of a hydrophobic fabric capable of allowing hydrocarbons to permeate therethrough, the dam supported on the base and containing granular material capable of collecting hydrocarbons.

14. The system of claim 13 wherein an outer periphery of the blanket is releaseably attached to the dam by at least one fastener for replacing the blanket after collecting sufficient hydrocarbons.

15. The system of claim 6 further comprising a grid supported on the skid and formed of rigid material, the grid being capable of supporting a user and allowing liquid to permeate therethrough and into the cavity.

16. A hydrocarbon containment system for placement under a vehicle, the system comprising:
a skid for resting upon a surface, the skid having a base capable of draining fluids therethrough;
a tubular dam formed of a hydrophobic fabric capable of allowing hydrocarbons to permeate therethrough, the dam supported on the base and containing granular material capable of collecting hydrocarbons; and
a collector adjacent the dam, the collector comprising spaced apart layers forming a chamber with granular material disposed within the chamber.

17. The system of claim 16 wherein the skid further comprises an adjacent raised periphery extending from the base.

18. The system of claim 16 wherein the spaced layers of the collector are formed of water permeable fabric.

19. The system of claim 17 wherein the periphery has a series of attachment apertures projecting therethrough.

20. The system of claim 16 wherein the collector is releasably attached to the tubular dam.
